(19) United States
(12) Patent Application Publication
(10) Pub. No.: US 2025/0271155 A1
(43) Pub. Date: Aug. 28, 2025

(54) Roof Vent Flashing with a Fire and Ember Barrier Border

(71) Applicant: O'Daniels, LLC., Henderson, NV (US)

(72) Inventors: David S. Mutter, Santa Rosa, CA (US); Gregory S. Daniels, Santa Rosa, CA (US); William B. Daniels, II, Las Vegas, NV (US)

(73) Assignee: O'Daniels, LLC., Henderson, NV (US)

(21) Appl. No.: 18/589,412

(22) Filed: Feb. 27, 2024

(51) Int. Cl. F24F 7/02; A62C 2/06; A62C 3/02

(52) U.S. Cl. CPC F24F 7/02; A62C 2/06; A62C 3/0214

(57) ABSTRACT

A vent as described herein provides for a fire and ember barrier border incorporated around the perimeter of vent flashing and/or sub-flashing. In the event that a portion of vent flashing separates from the underlayment to which it was originally attached, it creates a secondary air path between the deck and the flashing and the fire and ember barrier border will prevent fire and embers from entering the secondary air path and ultimately the building.

### FIELD OF THE INVENTIONS

The inventions described below relate to the field of vents for building ventilation.

### BACKGROUND OF THE INVENTIONS

Energy efficiency is a serious consideration in every building. Residential buildings require ventilation systems to minimize heat and moisture buildup in the uninhabited spaces within the building such as roofs, soffits, attics, basements and crawl spaces. In areas with extreme weather, rain, fire and embers, these undesirable elements are often driven into and through ventilation systems causing damage to the building, sometimes completely destroying it. In many circumstances the undesirable elements enter the ventilation system around and under flashing and/or sub-flashing that was either installed incorrectly, inexpertly, or has aged badly and separated from the underlayment.

### SUMMARY

The devices and methods described below provide for a fire and ember barrier border incorporated around the entire perimeter of vent flashing and sub-flashing. In the event that a portion of vent flashing separates from the underlayment to which it was originally attached, the separation creates a secondary air path between the underlayment and the flashing and the fire and ember barrier border will prevent fire and embers from entering the secondary air path and ultimately the building.

### BRIEF DESCRIPTION OF THE DRAWINGS

FIG. 1 is a simplified perspective view of a building with ventilation through the roof, foundation and gable.

FIG. 2 is a perspective view of a low profile roof vent with a fire and ember barrier border suitable for use on the building of FIG. 1.

FIG. 3 is a cross section view of the vent of FIG. 2 taken along A-A.

FIG. 4 is a top view of the vent of FIG. 2.

FIG. 5 is a bottom view of the vent of FIG. 2.

FIG. 6 is a perspective view of a flat tile roof with a shape matching vent.

FIG. 7 is a perspective view of an S-type tile roof with a shape matching vent.

FIG. 8 is a cross section view of the vent of FIG. 6 taken along B-B.

FIG. 9 is a cross section view of the vent of FIG. 7 taken along C-C.

FIG. 10 is a top perspective view of an M-type secondary vent.

FIG. 11 is a bottom perspective view of the vent of FIG. 10.

FIG. 12 is a side view of the vent of FIG. 10.

FIG. 13 is a perspective view of a passive foundation vent with a fire and ember barrier border.

FIG. 14 is a cross-section view of the passive foundation vent of FIG. 13 with a fire and ember barrier border taken along E-E.

FIG. 15 is a top view of a primary vent with a fire and ember resistant border.

FIG. 16 is a side view of the primary vent with a fire and ember resistant border of FIG. 13.

FIG. 17 is an end view of the primary vent with a fire and ember resistant border of FIG. 13.

FIG. 18 is a bottom view of the primary vent with a fire and ember resistant border of FIG. 13.

### DETAILED DESCRIPTION OF THE INVENTIONS

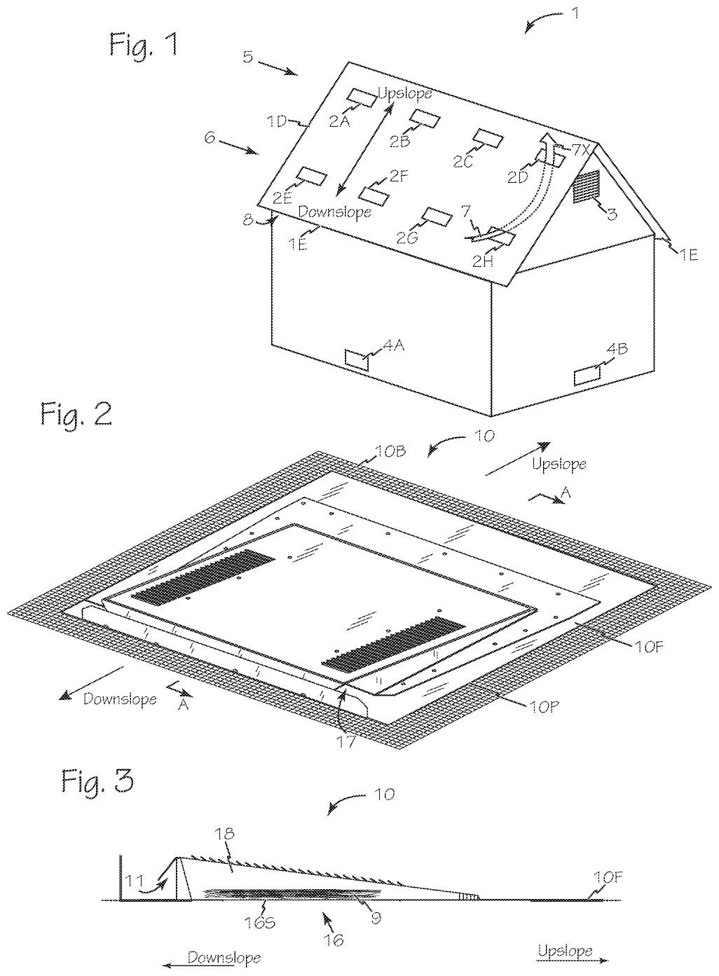

Buildings such as building 1 of FIG. 1 have one or more ventilation apertures, such as apertures 2A-2H, through the roof deck 1D, apertures under the eaves, aperture 3 in the gable, or apertures 4A and 4B to permit ventilation of the basement, crawlspace, cellar, and or undercroft of the building. The ventilation apertures on the roof may be arranged with some apertures higher and or lower on the roof to optimize passive ventilation of the building. For example, the upper or upslope apertures 5 such as apertures 2A-2D are oriented high on the roof, upslope from the lower or downslope apertures 6, such as apertures 2E-2H. This orientation permits passive air circulation, convection, with outside air 7 entering the lower apertures and exiting the upper apertures as exhaust air 7X carrying heat and moisture from within the attic. Lower apertures may be located through the roof deck or alternatively or in addition to having lower apertures on the roof deck one or more additional eave apertures 8 may be included under the eaves 1E of the building.

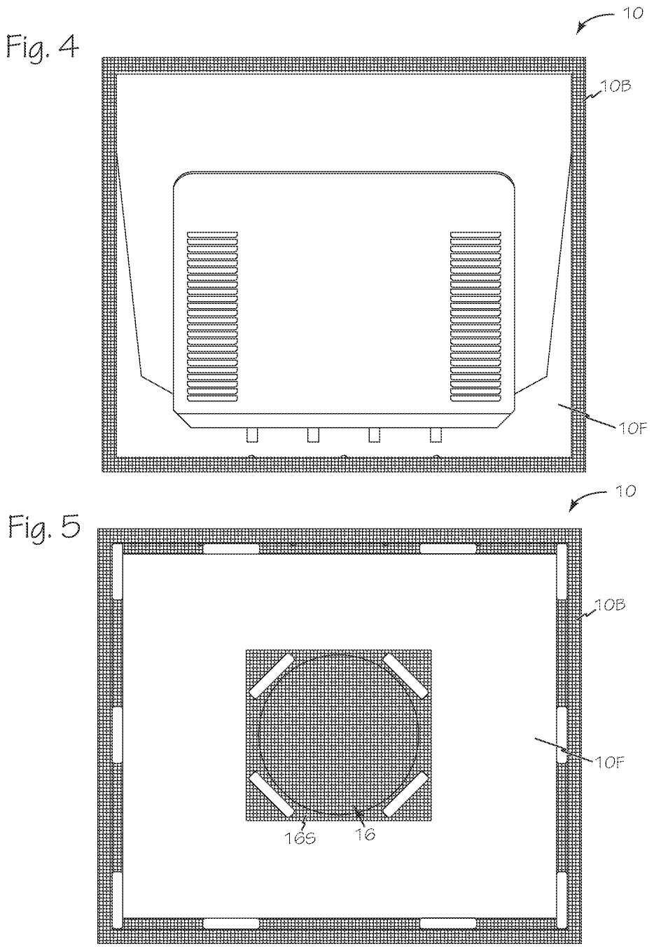

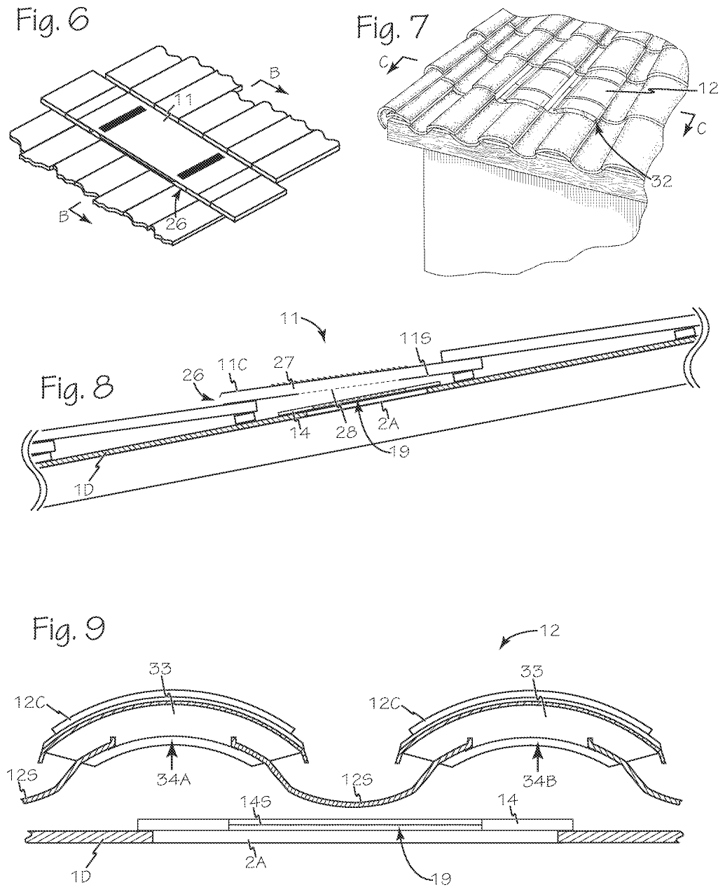

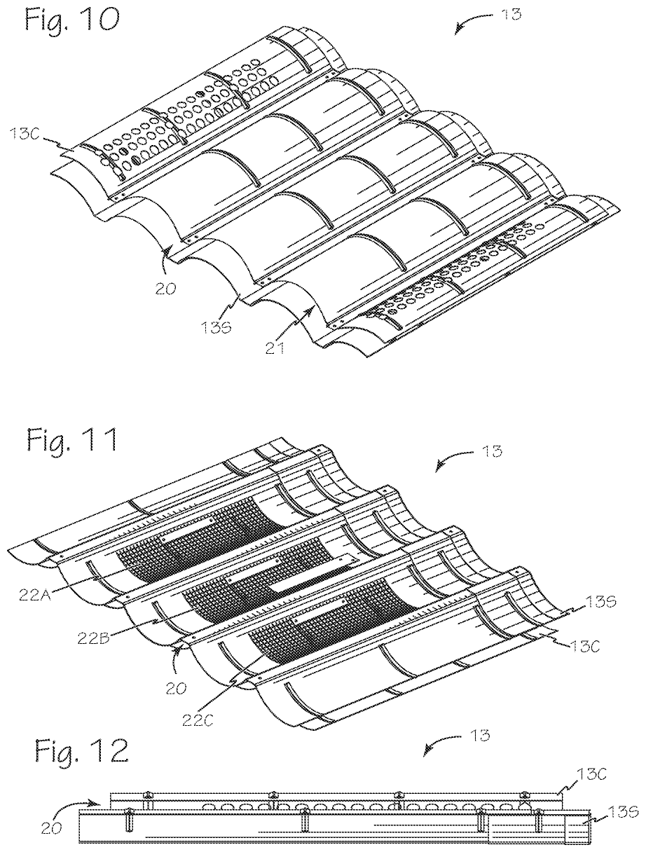

Any building ventilation aperture, such as the ventilation apertures 2A-2H, 3, 4A and 4B, are protected by any suitable vent cover such as the low profile vent 10 of FIGS. 2 and 3 which is suitable for use with shingle, metal, slate or shake roofs, flat tile vent 11 of FIGS. 6 and 8 which is suitable for use with flat clay or concrete roof tiles, S-type vent 12 of FIGS. 7 and 9 which is suitable for use with S-type clay or concrete roof tiles, M-type vent 13 of FIGS. 10, 11 and 12 which is suitable for use with S-type clay or concrete roof tiles or foundation vent 15 which is suitable for foundation uses to ventilate basements and crawl spaces.

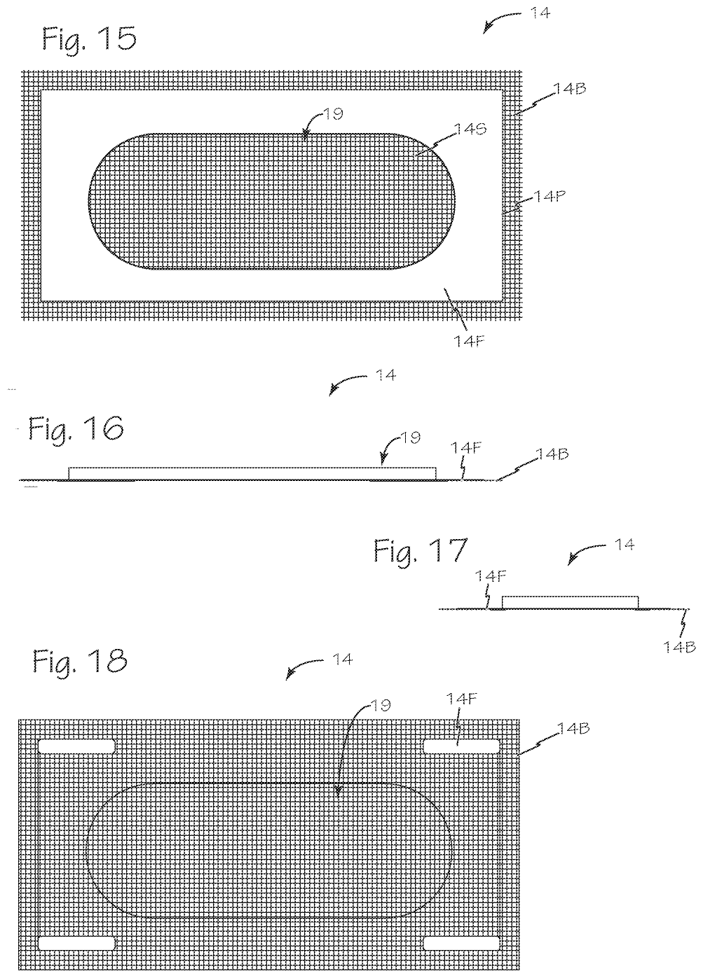

Two-piece vents are composed of a primary vent and a secondary vent in fluid communication. Flat tile vent 11, S-type vent 12 and M-type vent 13 are secondary vents and are illustrated in FIGS. 6 through 12. Primary vent 14 is illustrated in FIGS. 15, 16, 17 and 18. A primary vent, such as vent 14, is located between any suitable two-piece vent and a ventilation aperture through the roof deck such as ventilation apertures 2A-2H and enables fluid communication between a ventilation aperture and the secondary vent as illustrated in FIGS. 8 and 9.

The low profile vent 10 of FIGS. 2, 3, 4 and 5 has vent flashing 10F with a fire and ember barrier border 10B secured to the flashing and extending around the perimeter 10P of the flashing. The vent flashing 10F and fire and ember barrier border 10B are secured to the roof deck 1D with the vent oriented with vent opening 16 in fluid communication with a ventilation aperture through the roof decking such as one of ventilation apertures 2A-2H. Vent flashing 10F as well as fire and ember barrier border 10B are secured to the deck using any suitable material, technique or combination of materials and techniques including without limitation adhesives, caulking and or fastening with staples, nails, screws, brads or other suitable components. Vent 10 includes a downslope vent opening 17 in fluid communication with vent cavity 18 as well as vent opening 16. Vent opening 16 is covered by screen 16S which is any suitable ventilation screen. Screen 16S and fire and ember barrier border 10B may be a suitable ventilation screen such as ¼″ steel mesh although any suitable material and mesh size may be used such as ⅛″ mesh made of stainless steel, brass, copper, plastic, intumescent material or other.

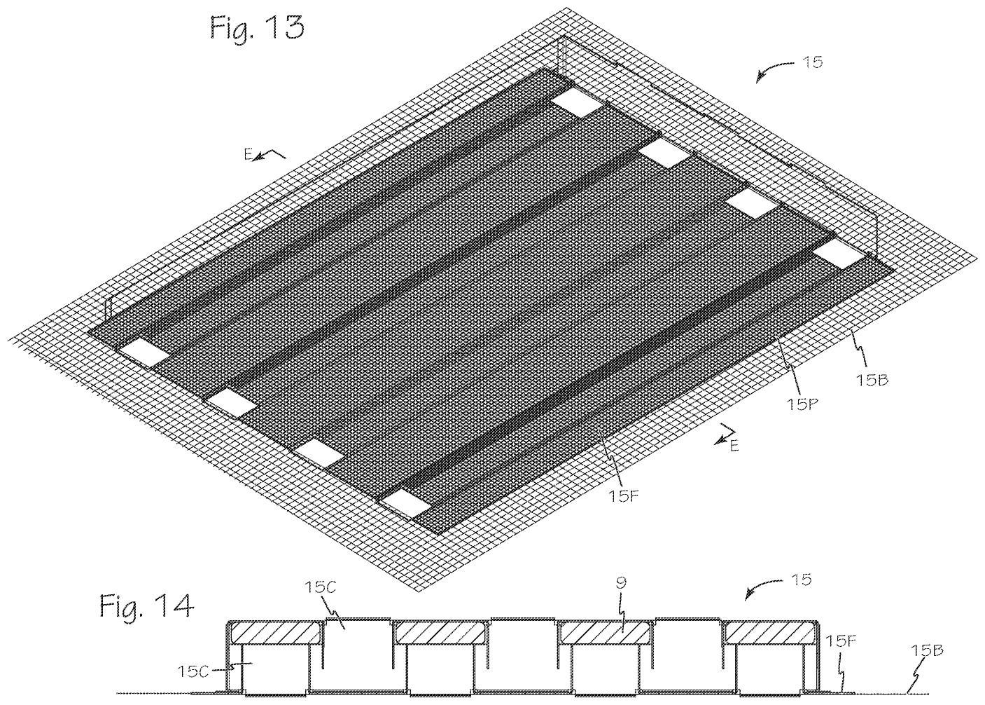

Similarly, foundation vent 15, illustrated in FIGS. 13 and 14, is directly secured into any suitable ventilation aperture such as foundation vent apertures 4A and 4B illustrated in FIG. 1. Foundation vent 15 includes vent cavity 15C in fluid communication between the building foundation space and the building exterior. Flashing 15F of foundation vent 15 has a perimeter 15P and fire and ember barrier border 15B is secured to the flashing 15F completely surrounding the perimeter 15P of flashing 15F. Flashing 15F and fire and ember barrier border 15B are secured to the building using any suitable material, technique or combination of materials and techniques including without limitation adhesives, caulking and or fastening with staples, nails, screws, brads or other suitable components. Fire and ember barrier border 15B may be a suitable ventilation screen such as ¼″ steel mesh although any suitable material and mesh size may be used such as ⅛″ mesh made of stainless steel, brass, copper, plastic, intumescent material or other.

Primary vent 14 is formed of flashing 14F with

ventilation opening 19 therethrough. Ventilation opening 19 is oriented to be in fluid communication with a suitable ventilation aperture such as ventilation apertures 2A-2H, 3, 4A and 4B. Primary vent 14 includes any suitable insect/vermin and debris barrier covering ventilation opening 19, such as screen 14S, and fire and ember barrier border 14B. Flashing 14F has a perimeter 14P, fire and ember barrier border 14B which is attached to the flashing, completely surrounds the perimeter 14P. Primary vent 14 is installed on a roof deck, such as deck 1D of FIG. 1, by fastening the flashing 14F and fire and ember barrier border 14B to the deck using any suitable material, technique or combination of materials and techniques including without limitation adhesives, caulking and or fastening with staples, nails, screws, brads or other suitable components. Primary vent 14 is oriented with ventilation opening over a ventilation opening or aperture, such as ventilation apertures 2A-2H, cut through the deck.

Any of vents 10, 11, 12, 13, 14, and or 15 may include optional filter mesh 9, as illustrated in FIGS. 3 and 14, to provide additional protection against debris and or embers transiting the vent system. The optional filter mesh is a flame-resistant interwoven mesh which may be any suitable material such as stainless steel. In a preferred configuration, the optional filter mesh is stainless steel wool made from alloy type AISI 434 stainless steel which forms a pad approximately ¼″ thick. The optional filter mesh may be secured to screen any of the skeletons, flashing or other suitable support using any suitable material or technique, including without limitation adhesives, caulking, welding, fastening, wrapping, stitching and the like.

Referring now to FIGS. 10, 11 and 12, M-type vent 13 has a skeleton 13S parallel to cap 13C. The orientation of skeleton 13S and cap 13C create a downslope vent opening 20 in fluid communication with vent cavity 21 formed between skeleton 13S and cap 13C. Skeleton 13S includes secondary ventilation openings 22A, 22B and 22C.

Flat tile vent 11 of FIGS. 6 and 8 has a skeleton 11S parallel to cap 11C. The orientation of skeleton 11S and cap 11C create a downslope vent opening 26 in fluid communication with vent cavity 27 formed between skeleton 11S and cap 11C. Skeleton 11S includes a secondary ventilation opening 28 in fluid communication with vent cavity 27 and downslope vent opening 26 as well as vent opening 19 of primary vent 14.

S-type vent 12 of FIGS. 7 and 9 has a skeleton 12S parallel to cap 12C. The orientation of skeleton 12S and cap 12C create a downslope vent opening 32 in fluid communication with vent cavity 33 formed between skeleton 12S and cap 12C. Skeleton 12S includes first and second secondary ventilation openings 34A and 34B which permit airflow from the attic through the primary vent and the secondary vent. Ventilation aperture 2A is in fluid communication with primary vent opening 19 which is in fluid communication with secondary vent openings 34A and 34B which are in fluid communication with vent cavity 33 which is in fluid communication with downslope vent opening 32.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A ventilation system for the roof of a building comprising:
a primary vent having flashing with a ventilation opening therethrough, the flashing having perimeter with a fire and ember barrier border secured to and surrounding the perimeter of the flashing, the ventilation opening in fluid communication with a ventilation aperture through the roof;
a debris barrier covering the ventilation opening; and
a secondary vent with a downslope ventilation opening in fluid communication with a vent cavity and one or more secondary vent openings in fluid communication with the ventilation opening of the primary vent.

2. The ventilation system of claim 1 wherein the fire and ember barrier border and the debris barrier are ¼″ steel mesh.

3. The ventilation system of claim 1 wherein the fire and ember barrier border and the debris barrier are ⅛″ steel mesh.

4. The ventilation system of claim 2 wherein the ¼″ steel mesh is stainless steel.

5. The ventilation system of claim 1 wherein the fire and ember barrier border and the debris barrier are ¼″ brass mesh.

6. The ventilation system of claim 1 wherein the fire and ember barrier border and the debris barrier are ¼″ copper mesh.

7. The ventilation system of claim 1 wherein the fire and ember barrier border and the debris barrier are ¼″ plastic mesh.

8. The ventilation system of claim 1 wherein the fire and ember barrier border and the debris barrier are ¼″ intumescent mesh.

9. The ventilation system of claim 3 wherein the ⅛″ steel mesh is stainless steel.

10. The ventilation system of claim 1 wherein the fire and ember barrier border and the debris barrier are ⅛″ brass mesh.

11. The ventilation system of claim 1 wherein the fire and ember barrier border and the debris barrier are ⅛″ copper mesh.

12. The ventilation system of claim 1 wherein the fire and ember barrier border and the debris barrier are ⅛″ plastic mesh.

13. The ventilation system of claim 1 wherein the fire and ember barrier border and the debris barrier are ⅛″ intumescent mesh.

14. the ventilation of claim 1 further comprising:
A filter mesh in the vent cavity.

15. A ventilation system comprising:
a low profile vent having flashing with a ventilation opening therethrough, the flashing having a perimeter with a fire and ember barrier border secured to and surrounding the perimeter of the flashing and a debris barrier covering the ventilation opening.

16. The ventilation system of claim 15 wherein the fire and ember barrier border and the debris barrier are ¼″ steel mesh.

17. The ventilation system of claim 15 wherein the fire and ember barrier border and the debris barrier are ⅛″ steel mesh.

18. A building ventilation system comprising:
a foundation vent having a flashing operable to secure the vent to a building, the flashing having a perimeter; and
a fire and ember barrier border secured to and surrounding the perimeter of the flashing.
